(19) United States
(12) Patent Application Publication
(10) Pub. No.: US 2006/0094359 A1
(43) Pub. Date: May 4, 2006

(54) Method for detecting bluetooth device using company ID

(75) Inventor: Sang-Don Kim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/263,288

(22) Filed: Oct. 31, 2005

(30) Foreign Application Priority Data
Oct. 29, 2004 (KR) 10-2004-0087315

(51) Int. Cl. H04B 7/00

(52) U.S. Cl. 455/41.2; 455/41.1

(57) ABSTRACT

Disclosed is a method for detecting a Bluetooth device by using a company ID. The method includes searching by a user equipment having a Bluetooth function in order to connect the user equipment to a desired Bluetooth device; and selecting and displaying information about counterpart Bluetooth devices, each of which has an address including a company ID identical to a predetermined company ID, from among searched Bluetooth devices. Therefore, when many Bluetooth devices besides a device desired to register by the user exist around the user equipment, the user can easily find the desired device by using company IDs.

### PRIORITY

This application claims priority under 35 U.S.C. 119(a) to an application entitled “Method For Detecting Bluetooth Device By Using Company ID” filed in the Korean Intellectual Property Office on Oct. 29, 2004 and assigned Serial No. 2004-87315, the entire contents of which are incorporated herein by reference.

### BACKGROUND OF THE INVENTION

1. Field of the Invention

The present invention relates to a system using Bluetooth, and more particularly to a method for detecting a Bluetooth device using a company identifier (ID).

2. Description of the Related Art

Bluetooth is a standard that is designed to support low-cost, short-range wireless communication between mobile devices such as portable PCs and portable telephones. Bluetooth uses radio frequencies in the 2.45 GHz ISM (Industrial Scientific Medical) band which does not require a wireless license, thereby enabling various digital devices to exchange voice and data with each other completely wirelessly without any physical connection. For instance, Bluetooth wireless technology may be employed in a portable telephone and a laptop computer so that they can communicate with each other even without a cable. Also, a Bluetooth system may include all digital devices, such as a Personal Digital Assistant (PDA), a desktop computer, a fax, a keyboard and a joystick.

FIG. 1 is a diagram illustrating general communication schemes between Bluetooth devices.

A user equipment 100 containing a Bluetooth chip establishes a wireless connection with adjacent Bluetooth devices 110 to 150 and supports point-to-point connection and point-to-multipoint connection. When the user equipment 100 requests detection of a Bluetooth device, information about the adjacent Bluetooth devices 110 to 150 is displayed on the user equipment 100. Then, the user equipment 100 starts a connection set-up procedure for connecting the user equipment 100 to a device desired to be connected from among the detected Bluetooth devices.

Increasingly now, many products employ Bluetooth, so various Bluetooth devices using different frequencies may be located together in the same space. Therefore, the user must spend time and effort in order to detect a counterpart device to which the user wants to connect within a limited display window of the user equipment. According to a conventional method proposed to solve such a problem, a user must obtain the specific address of a counterpart device desired to be connected and then directly inputs the specific address (i.e., a twelve-digit hex code).

However, the conventional detection method as described above has problems in that it is not easy to find the specific address of a counterpart device and also it is very inconvenient to input a twelve-digit hex code in a device having limited keys, such as in a mobile telephone.

### SUMMARY OF THE INVENTION

Accordingly, the present invention has been made to solve the above-mentioned problems occurring in the prior art, and an object of the present invention is to provide a method by which a user's Bluetooth device can easily and rapidly find and connect to a desired counterpart Bluetooth device.

Another object of the present invention is to provide a method for detecting a Bluetooth device by using an ID assigned to a particular manufacturer (a “company ID”) in a specific address of the Bluetooth device.

To accomplish these objects, in accordance with one aspect of the present invention, a method is provided for detecting a Bluetooth device by using a company ID, the method including the steps of searching by a user equipment having a Bluetooth function in order to connect the user equipment to a desired Bluetooth device; and selecting and displaying information about counterpart Bluetooth devices, each of which has an address including a company ID identical to a predetermined company ID, from among searched Bluetooth devices.

In accordance with another aspect of the present invention, a method is provided for detecting a Bluetooth device by using a company ID. The method includes the steps of searching by a user equipment having a Bluetooth function in order to connect the user equipment to a desired Bluetooth device; and displaying information about the searched Bluetooth devices in regular sequence according to relevant company IDs.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating general communication schemes between Bluetooth devices;

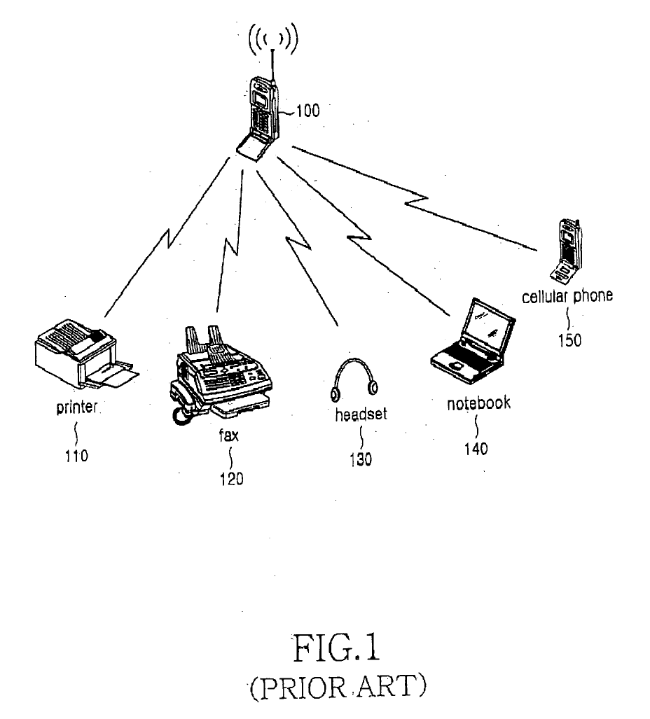

FIG. 2 shows a table of company ID information according to an embodiment of the present invention;

FIG. 3 is a diagram illustrating a message transmission procedure between Bluetooth devices according to an embodiment of the present invention;

FIG. 4 is a flowchart illustrating an operation of a Bluetooth device according to an embodiment of the present invention; and

FIG. 5 is a flowchart illustrating an operation of a Bluetooth device according to another embodiment of the present invention.

### DETAILED DESCRIPTION OF THE PREFERRED EMBODIMENT

Hereinafter, preferred embodiments of the present invention will be described with reference to the accompanying drawings. In the following description of the embodiments of the present invention, a detailed description of known functions and configurations incorporated herein will be omitted when it may obscure the subject matter of the present invention. One feature of a Bluetooth technique is that developers can use the existing Bluetooth techniques, without any other condition except that the developers must join a special interface group (SIG). When a technique relating to Bluetooth is developed by a developer, the technique also must be able to be used unconditionally by other developers. For this reason, the SIG assigns a special number for each company joining the association to the first two digits of a 12-digit specific address for a Bluetooth device, this being a Bluetooth company ID. Information about the company IDs can be obtained from the web site of http://standards.ieee.org/regauth/oui/oui.txt.

According to the present invention, a Bluetooth device can display information about company IDs, which corresponds to Bluetooth devices found through a search, on the display window of the user equipment.

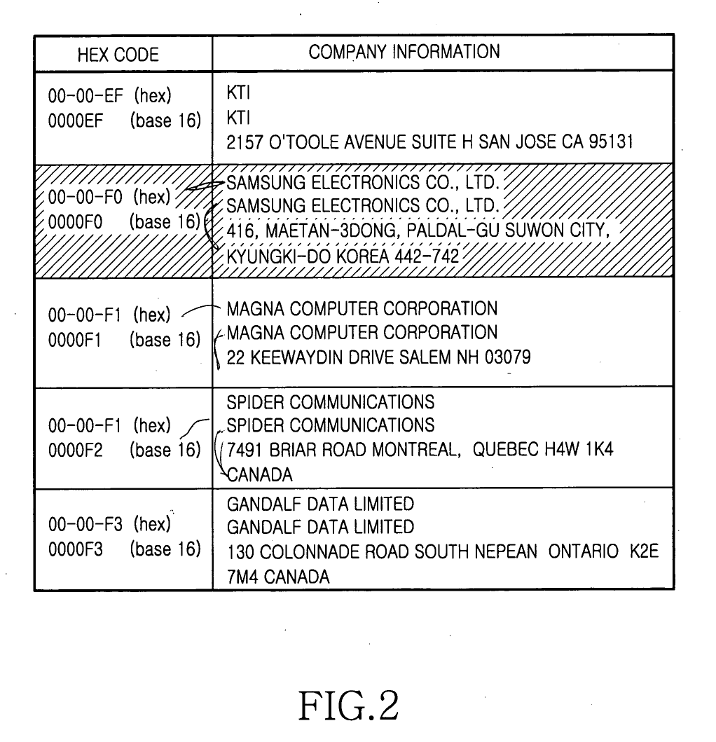

Turning to FIG. 2, FIG. 2 shows company IDs of several companies such as, KTI, SAMSUNG ELECTRONICS CO., LTD., MAGNA COMPUTER CORPORATION, SPIDER COMMUNICATIONS and GANDALF DATA LIMITED. In the case of the SAMSUNG ELECTRONICS CO., LTD., its Bluetooth address starts with “0000F0”. Therefore, if the user knows the company name for the manufacturer of a Bluetooth device for which a connection is sought, the user can easily find the desired Bluetooth device by using its company ID.

Bluetooth devices are used to connect of at least two pieces of equipment having the Bluetooth technology. For such a connection, it is necessary to perform a so-called pairing procedure.

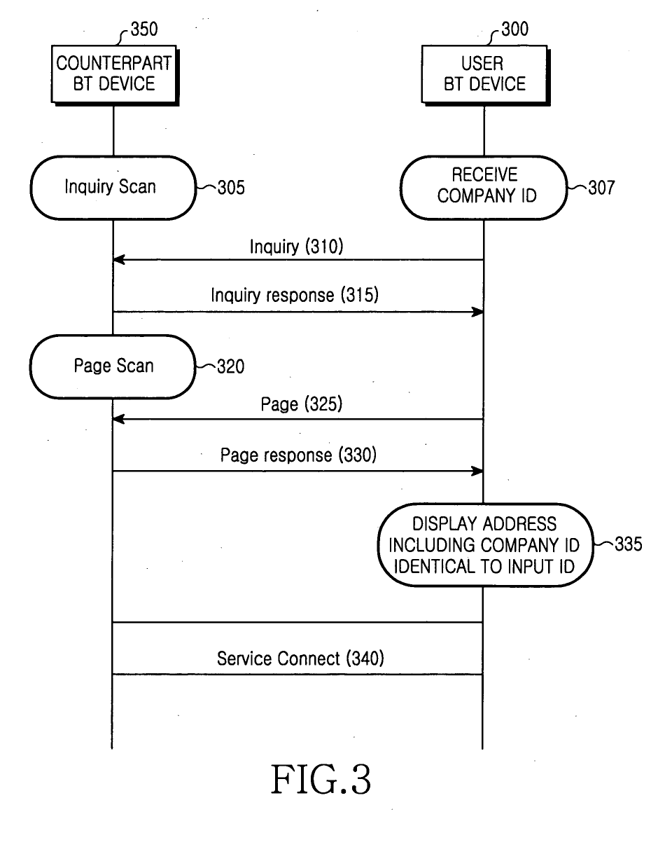

According to the pairing scheme, a first device must be in an inquiry scan state while a second device is sending an inquiry to detect a counterpart device for connection. When having detected the counterpart device for connection, the second device browses a service required in the detected device and then is connected to the service of the detected device. FIG. 3 illustrates a detection procedure between Bluetooth devices according to an embodiment of the present invention. In step 307, a user equipment (or user BT device) 300 receives a company ID or a company name of a Bluetooth device desired to be connected. The company ID has been assigned to the desired Bluetooth device or has been recognized by the user in advance.

In step 310, the user equipment 300 broadcasts an inquiry message to detect the Bluetooth device desired to be connected. In this case, a counterpart Bluetooth device 350, which may be either a Bluetooth device desired to be connected by the user equipment 300 or a Bluetooth device not desired to be connected by the user equipment 300, is in an inquiry scan state 305.

In step 315, the counterpart Bluetooth device 350 having received the inquiry message sends its own Bluetooth device address (BD_ADDR) and clock information to respond to the user equipment 300, and then enters a page scan state 320 for connection set up. Although it is not shown, the inquiry message 310 is received in all adjacent Bluetooth devices being in an inquiry scan state, besides the counterpart Bluetooth device 350, so as to cause the same procedure to occur in the adjacent Bluetooth devices.

In step 325, the user equipment 300 sends a page message for synchronization, which has been obtained with reference to the received BD_ADDR and clock information, to the counterpart Bluetooth device 350. In step 330, the counterpart Bluetooth device 350 transmits a page response message including an ID packet in response to the page message. The ID packet may include various information about the counterpart Bluetooth device 350 (i.e., information whether the counterpart device is a headset or a terminal, information about its manufacturing company, a hex code, etc.). In step 335, the user equipment 300 displays information (i.e., address) about the counterpart Bluetooth device 350, which has the company ID coinciding with the input company ID, on the display window of the user equipment 300.

That is, the user equipment 300 extracts Bluetooth devices having the same company ID as the input company ID, from among many detected Bluetooth devices. To be specific, the user equipment 300 begins detection of the IDs of counterpart Bluetooth terminals. Then, the user equipment 300 reads six digits of the Bluetooth address, and displays Bluetooth devices corresponding to the read digits as a selected result on the display unit of the user equipment 300.

When the user selects the Bluetooth device 350 desired to be connected from among the displayed Bluetooth devices, a link for data transmission/reception is set up between the user equipment 300 and the counterpart Bluetooth device 350 in step 340. After such a link set up procedure is normally completed, data are transmitted/received.

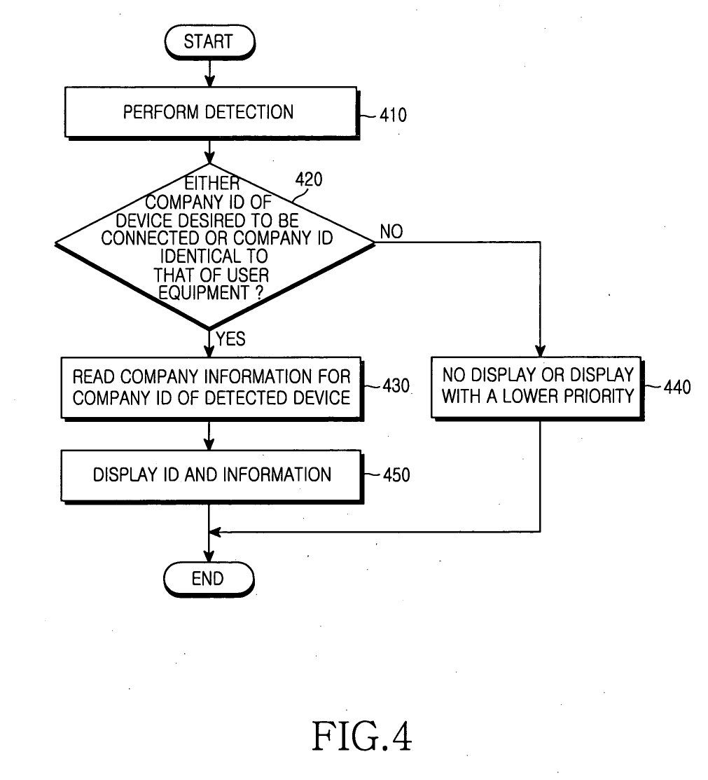

FIG. 4 is a flowchart illustrating an operation of a Bluetooth device in which addresses, including either the company ID of a Bluetooth device input for connection by the user or the same company ID as that of the user equipment, are first displayed. For example, when a mobile telephone (user equipment) wants to be connected to a product (such as an earphone, a computer hardware, a key board, a mouse or the like) manufactured by the same manufacturer as that of the mobile telephone, the present invention can be efficiently applied to the detection of adjacent Bluetooth devices.

In step 410, a user equipment performs a detection to receive addresses from detected Bluetooth devices. In step 420, for each of the detected Bluetooth devices, it is determined whether or not the first six digits of the address of the detected Bluetooth device is identical to either the company ID of a device desired to be connected or the company ID of the user equipment. As a result of step 420, when the first six digits of the address of the detected Bluetooth devices are identical to either the company ID of the desired device or the company ID of the user equipment, the user equipment reads company information corresponding to the detected device having the ID of either the desired device or the user equipment in step 430. Then, the read company information is displayed together with the address of including the relevant company ID at step 450. In this case, the user equipment has stored company IDs and company information (e.g., company names) in advance and displays company information corresponding to the address of a detected device.

In contrast, as a result of step 420, when the first six digits of the address of the detected Bluetooth devices are not identical to either the company ID of the desired device or the company ID of the user equipment, the user equipment does not display or displays with a lower priority the information about the devices having a company ID to which the user equipment does not want to connect in step 440. Herein, the term ‘display with a lower priority’ implies that information of the devices having the desired company ID is displayed at higher positions in a detection result list while information of the devices having the undesired company ID is displayed at lower positions in the list.

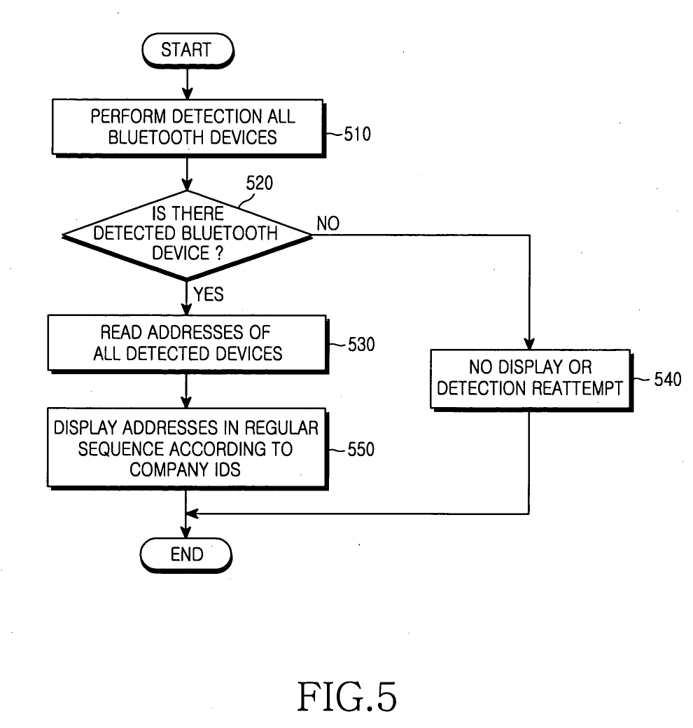

FIG. 5 is a flowchart illustrating an operation of a Bluetooth device, such that when a detection is performed, information of all detected Bluetooth devices is displayed in regular sequence according to company IDs with no company ID input in advance.

In step 510, the user equipment performs a detection of adjacent Bluetooth devices to receive addresses from the detected Bluetooth devices. In step 520, the user equipment determines whether there is a detected Bluetooth device. As a result of step 520, when there is a detected Bluetooth device, the user equipment reads the company ID corresponding to the first six digits of the address received from each detected Bluetooth device in step 530, and displays information about the detected Bluetooth devices on a display window in regular sequence according to the company IDs in step 550. In this case, the user equipment may display pre-stored company information relating to the detected Bluetooth devices, together with the detected Bluetooth device information.

In contrast, as a result of step 520, if there is no detected Bluetooth devices, that indicates a situation in which a Bluetooth device does not exist around the user equipment, or a case in which an adjacent Bluetooth device is not in an inquiry scan state or a page scan state. In this case, the user equipment does not display a detection result or again attempts the detection in step 540.

According to another embodiment of the present invention, the user equipment receives information about manufacturing companies together with addresses from detected Bluetooth devices, and displays information about the detected Bluetooth devices in regular sequence according to manufacturing companies.

According to the embodiments of the present invention, when there are many Bluetooth devices in proximity to the user equipment in addition to the device that is desired to be registered, the user can find the desired device easily by using company IDs.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for detecting a Bluetooth device using a company ID, the method comprising the steps of:
searching by a user equipment having a Bluetooth function to detect a desired Bluetooth device in order to connect the user equipment to the desired Bluetooth device; and
selecting and displaying information about counterpart Bluetooth devices, each of which has an address including a company ID identical to a predetermined company ID, from among searched Bluetooth devices.

2. The method as claimed in claim 1, wherein the predetermined company ID is a company ID of the desired Bluetooth device.

3. The method as claimed in claim 1, wherein the predetermined company ID is a company ID identical to that of the user equipment performing the searching.

4. The method as claimed in claim 1, wherein, in the step of searching, the user equipment receives addresses of the searched Bluetooth devices and compares a first six-digit hex code representing a relevant company in each of the addresses with the predetermined company ID.

5. The method as claimed in claim 1, wherein the information about the Bluetooth devices includes address and company information of the searched Bluetooth devices.

6. The method as claimed in claim 5, wherein the company information is pre-stored to correspond to relevant company IDs in the user equipment.

7. A method for detecting a Bluetooth device using a company ID, the method comprising the steps of:
searching by a user equipment having a Bluetooth function to detect a desired Bluetooth device in order to connect the user equipment to the desired Bluetooth device; and
displaying information about the searched Bluetooth devices in regular sequence according to relevant company IDs.

8. The method as claimed in claim 7, in the step of searching, the user equipment receives addresses of the searched Bluetooth devices and reads a company ID which is contained in first six digits of each of the received addresses.

9. The method as claimed in claim 7, wherein the information about the Bluetooth devices includes addresses and company information of the searched Bluetooth devices.

10. The method as claimed in claim 9, wherein the company information is pre-stored to correspond to relevant company IDs in the user equipment performing the searching.

11. The method as claimed in claim 7, wherein, in the displaying step, the user equipment first displays information about Bluetooth devices having a company ID identical to a predetermined company ID, from among the searched Bluetooth devices.

12. The method as claimed in claim 11, wherein the predetermined company ID is a company ID of the desired Bluetooth device.

13. The method as claimed in claim 11, wherein the predetermined company ID is a company ID identical to that of the user equipment performing the searching.
